(19) United States
(12) Patent Application Publication
(10) Pub. No.: US 2009/0091910 A1
(43) Pub. Date: Apr. 9, 2009

(54) Keypad with increased refractive index

(76) Inventor: Hsin-Chin Lee, Jhongli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,460

(22) Filed: Jul. 23, 2008

(30) Foreign Application Priority Data
Oct. 5, 2007 (TW) 96216678

(51) Int. Cl. G01D 11/28

(52) U.S. Cl. 362/26

(57) ABSTRACT

A keypad with increased refractive index includes a light-guiding elastic element, an optical refractive layer and at least one light-emitting element. The optical refractive layer is applied on an upper surface of the light-guiding elastic element. The light-emitting element is provided on one side of the light-guiding elastic element. The refractive index of air is defined as a real number x. The refractive index of the light-guiding elastic element is defined as a real number y. The refractive index of the optical refractive layer is defined as a real number z. The refractive index z is larger than the refractive index x. Since the optical refractive layer is applied on the light-guiding elastic element and the refractive index of the optical refractive layer is different from that of the light-guiding elastic element, the angle of total reflection of the light in the light-guiding elastic element can be changed.

### BACKGROUND OF THE INVENTION

1. Field of the Invention

The present invention relates to a keypad, and in particular to a keypad with increased refractive index, whereby the angle of total reflection of light can be changed so as to increase the amount of transmitted light.

2. Description of Related Art

With the advent of the information technology era and the development of communication network technology, cell phones (also referred to as mobile phones) have become one of the most popular communication tools. Since the mobile phone is small in volume, easy to carry, and has various functions at a low price, more and more consumers like to use mobile phones. When the consumer chooses a mobile phone, the functionality and profile of the mobile phone are the chief considerations. Therefore, in order to satisfy the consumer's demands, many mobile phones have been developed with various functions and novel profiles.

In order to illuminate the letters shown on the keys of a mobile phone, light-emitting diodes are disposed as a light source below the keys. The emitted light is scattered by the rubber constituting the key, so that the light transmittable letters shown on the keys can be illuminated.

However, the currently-used rubber has low transparency. Therefore, much of the emitted light is absorbed by the rubber, so that the light does not project very far. Thus, it is necessary to use 6 to 8 light-emitting diodes as a light source to merely illuminate the neighboring region of the letters on the key.

In the prior art, a material with high transparency is used to reduce the loss of light. However, such a solution still requires four light-emitting diodes. Therefore, in the above-mentioned solution, the efficiency of light transmission and the uniformity are poor.

Therefore, according to the above, in practice, the conventional key still has drawbacks and thus needs to be improved. On the other hand, there is a tendency toward a better luminance and uniformity of the key. Thus, it is an important issue for those skilled in this art to use fewer light sources or the same number of light sources with improved optical structure, thereby achieving high efficiency and uniformity.

Consequently, because of the above limitation resulting from the technical design of prior art, the inventor strives via real world experience and academic research to develop the present invention, which can effectively improve the limitations described above.

### SUMMARY OF THE INVENTION

The object of the present invention is to provide a keypad with increased refractive index, whereby the angle of total reflection of the light can be changed so as to increase the amount of transmitted light.

In order to achieve the above objects, the present invention provides a keypad with increased refractive index, which includes a light-guiding elastic element; an optical refractive layer applied on an upper surface of the light-guiding elastic element, the refractive index of air being defined as a real number x, the refractive index of the light-guiding elastic element being defined as a real number y, the refractive index of the optical refractive layer being defined as a real number z, the refractive index y being larger than the refractive index z, the refractive index z being larger than the refractive index x; and at least one light-emitting element provided on one side of the light-guiding elastic element.

The present invention has advantageous features as follows. Since the optical refractive layer is applied on an upper surface of the light-guiding elastic element, and the refractive index of the optical refractive layer is different from that of the light-guiding elastic element. The angle of total reflection of the light in the light-guiding elastic element can be changed, causing more light to be guided outside of the light-guiding elastic element. In this way, the number of light sources used in the light-guiding elastic element can be increased. Furthermore, the luminance and uniformity of the light can be enhanced, thereby improving the optical behavior of the keypad and increasing the efficiency of the light source and a battery.

In order to further understand the characteristics and technical contents of the present invention, a detailed description relating thereto will be made with reference to the accompanying drawings. However, the drawings are illustrative only, and not to be used to limit the scope of the present invention.

### BRIEF DESCRIPTION OF THE DRAWINGS

FIG. 1 is an exploded view of the present invention;

FIG. 2 is an assembled view of the present invention; and

FIG. 3 is a view showing the details of a portion A in FIG. 2.

### DETAILED DESCRIPTION OF THE PREFERRED EMBODIMENTS

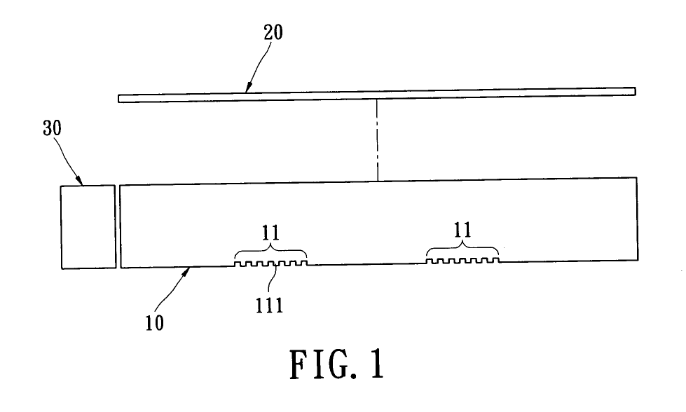

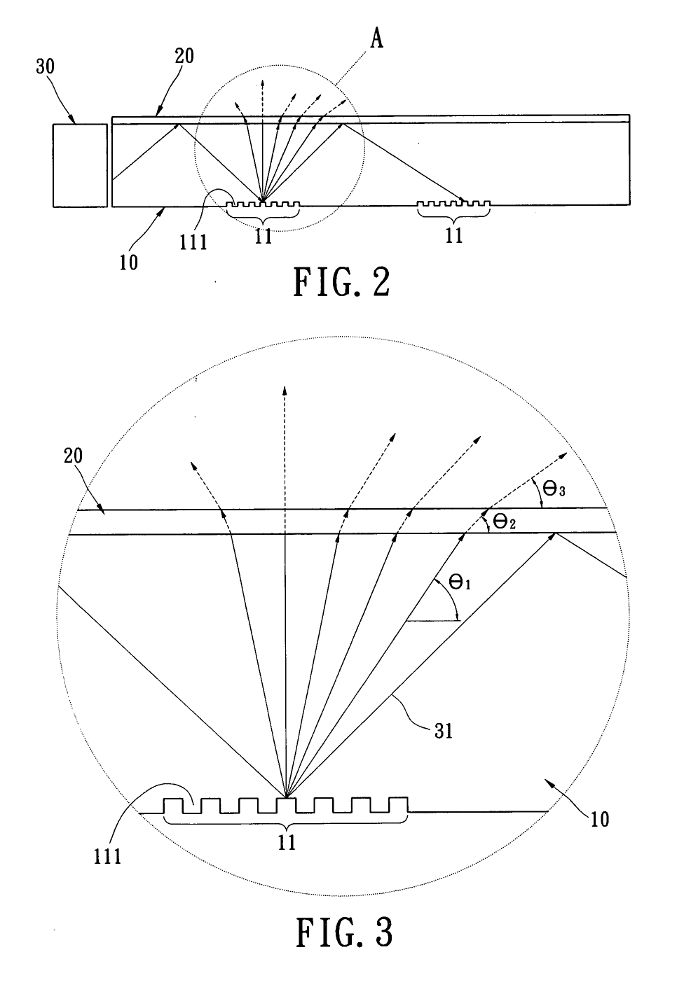

Please refer to FIGS. 1 and 2. The present invention provides a keypad with increased refractive index, which includes a light-guiding elastic element 10, an optical refractive layer 20 and at least one light-emitting element 30.

The light-guiding elastic element 10 is made of transparent rubber material or transparent plastic material. The lower surface of the light-guiding elastic element 10 is provided with a plurality of light-guiding microstructures 11. Each of the light-guiding microstructures 11 is provided with a plurality of troughs 111.

The optical refractive layer 20 is transparent and is applied on the upper surface of the light-guiding elastic element 10 by means of coating. The optical refractive layer 20 is made of materials having optical properties, such as SiO₂.

The refractive index of air is defined as a real number x. The refractive index of the light-guiding elastic element 10 is defined as a real number y. The refractive index of the optical refractive layer 20 is defined as a real number z. The refractive index y is larger than the refractive index z, and the refractive index z is larger than the refractive index x. That is, y>z>x. More specifically, the theoretical value of the refractive index x (i.e. air) is 1. The refractive index y of the light-guiding elastic element 10 may be made into different values based on the type of materials used, which is in a range of 1.4 to 1.6 and preferably 1.58. The refractive index z of the optical refractive layer 20 may be made into different values based on the type of materials used, which should be smaller than the refractive index of the light-guiding elastic element 10 and is in a range of 1.2 to 1.5, preferably 1.48.

The light-emitting element 30 is disposed on one side of the light-guiding elastic element 10. In the drawings of the present invention, one light-emitting element 30 is provided. Of course, two light-emitting elements can be provided on one side of the light-guiding elastic element 10. The light-emitting element 30 can be a light-emitting diode.

According to the above, with reference to FIG. 3, when the light-emitting element 30 emits a light beam 31 (as indicated by arrows) to the light-guiding elastic element 10, a portion of the light beam 31 traverses the optical refractive layer 20 directly via the light-guiding microstructures 11. Then, this portion of light beam passes through the optical refractive layer 20 and enters the air. Another portion of the light beam 31 will be refracted to achieve the lower surface of the light-guiding elastic element 10, and thus pierces the optical refractive layer 20 via another light-guiding microstructure 11. Thereafter, this another portion of the light passes through the optical refractive layer 20 and enters the air.

Since the refractive index y of the light-guiding elastic element 10 is larger than the refractive index z of the optical refractive layer 20, according to the principle of refraction, the optical refractive layer 20 changes the original angle θ₁ of the light 31 coming from the light-guiding elastic element 10, thereby generating an angle θ₂ that is smaller than θ₁. In this way, the angle of total reflection of the light-guiding elastic element 10 can be changed. The light 31 can be reflected by the optical refractive layer 20 and enters the air. Since the refractive index y of the optical refractive layer 20 is larger than of the refractive index x of the air, an angle θ₃ that is smaller than of the angle θ₂ can be generated. In this way, the angle of total reflection can be changed. As mentioned in the above, via the optical refractive layer 20, the angle of total reflection of the light-guiding elastic element 10 can be changed, thereby guiding more light 31 to the outside of the light-guiding elastic element 10 and increasing the amount of light falling onto the light-guiding elastic element 10.

According to the above, in the present invention, the optical refractive layer 20 is applied on the upper surface of the light-guiding elastic element 10 and the refractive index of the optical refractive layer is different from that of the light-guiding elastic element, the angle of total reflection of the light 31 of the light-guiding elastic element can be changed, so that more light can be guided to the outside of the light-guiding elastic element 10. In this way, the amount of light falling onto the light-guiding elastic element 10 can be increased and the luminance and uniformity of the light can be improved. Therefore, the optical behavior of the keypad is improved, the efficiency of the light source is increased, and battery life can be prolongued. That is, the number of the light-emitting elements 30 is reduced, thereby saving electricity.

Furthermore, incidentally, according to the selected material of the optical refractive layer 20, the original color of the light-emitting element 30 can be changed, thereby generating different colors.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A keypad with increased refractive index, comprising:
a light-guiding elastic element;
an optical refractive layer applied on an upper surface of the light-guiding elastic element, the refractive index of air being defined as a real number x, the refractive index of the light-guiding elastic element being defined as a real number y, the refractive index of the optical refractive layer being defined as a real number z, the refractive index y being larger than the refractive index z, the refractive index z being larger than the refractive index x; and
at least one light-emitting element provided on one side of the light-guiding elastic element.

2. The keypad with increased refractive index according to claim 1, wherein the light-guiding elastic element is made of transparent rubber or transparent plastic.

3. The keypad with increased refractive index according to claim 1, wherein the lower surface of the elastic element has a plurality of light-guiding microstructures.

4. The keypad with increased refractive index according to claim 3, wherein each of the light-guiding microstructures is provided with a plurality of troughs.

5. The keypad with increased refractive index according to claim 1, wherein the theoretical value of the refractive index x is 1, the refractive index y is in the range of 1.4 to 1.6, and the refractive index z is in the range of 1.2 to 1.5.

6. The keypad with increased refractive index according to claim 1, wherein the light-emitting element is a light-emitting diode.
